(19) United States
(12) Patent Application Publication
(10) Pub. No.: US 2006/0082314 A1
(43) Pub. Date: Apr. 20, 2006

(54) Spiral cold cathode fluorescent lamp

(76) Inventor: Dennis Tung, Taipei (TW)

Correspondence Address: DENNISON, SCHULTZ, DOUGHERTY & MACDONALD, 1727 KING STREET, SUITE 105, ALEXANDRIA, VA, 22314, US

(21) Appl. No.: 10/965,838

(22) Filed: Oct. 18, 2004

(51) Int. Cl. H01J 61/20; H01J 17/20

(52) U.S. Cl. 313/639

(57) ABSTRACT

Disclosed is a spiral cold cathode fluorescent lamp which has the two distal ends of the glass tube thereof bent inwards toward each other and then spirally bent in reversed directions over each other under a high temperature environment, thereby forming a spiral shape.

### BACKGROUND OF THE INVENTION

(a) Field of the Invention

The present invention relates generally to a cold cathode fluorescent lamp and more particularly, to a spiral cold cathode fluorescent lamp.

(b) Description of the Prior Art

A lamp bulb produces light by means of sending electric current through a high impedance filament (tungsten). A fluorescent lamp is a tubular electric lamp that is coated on its inner surface with a phosphor and that contains mercury vapor whose bombardment by electrons from the cathode provides ultraviolet light, which causes the phosphor to emit visible light. However, about 40% of electric energy will be converted into heat energy during the operation of a fluorescent lamp. There is also known a cold cathode fluorescent lamp, which is a low voltage mercury discharging lamp comprised of a glass tube with two electrodes at the two distal ends, a fluorescent material coated on the inner surface of the glass tube, an inert gas enclosed inside the glass tube, and mercury enclosed inside the glass tube. Bombardment of mercury atoms by electrons provides ultraviolet light, which causes the fluorescent material to emit visible light (white light, blue light, or ultraviolet light).

A conventional cold cathode fluorescent lamp is durable and stable in use, consumes low amount of electricity, and produces little heat during operation. The glass tube a regular cold cathode fluorescent lamp is a straight tube having a diameter within about 1.8 mm˜4.1 mm. Because of low lux, a conventional cold cathode fluorescent lamp is not suitable for use as a desk lamp or lighting fixture for illumination. Therefore, conventional cold cathode fluorescent lamps are commonly used in instruments, or for the purpose of indication or decoration.

Taiwan utility model no. 579050 discloses a simple type cold cathode fluorescent lamp, which has the cold cathode fluorescent lamp tube installed in an outer tube that admits light. Taiwan utility model no. 556793 discloses a cold cathode fluorescent lamp holder shell, which uses a hollow tubular handle to accommodate a cold cathode fluorescent lamp. These utility models still utilize conventional straight type cold cathode fluorescent lamp tubes, i.e., have the drawback of low lux.

### SUMMARY OF THE INVENTION

The present invention has been accomplished under the circumstances in view. It is the main object of the present invention to provide a cold cathode fluorescent lamp, which has a spiral glass tube design. To achieve this and other objects of the present invention, the spiral cold cathode fluorescent lamp comprises a glass tube, which has two electrodes respectively installed in the two distal ends thereof, a fluorescent material coated on an inside wall of the glass tube, an inert gas enclosed inside the glass tube, and mercury enclosed inside the glass tube, wherein the glass tube has the two distal ends thereof bent inwards toward each other and then spirally bent in reversed directions over each other under a high temperature environment, thereby forming a spiral cold cathode fluorescent lamp.

### BRIEF DESCRIPTION OF THE DRAWINGS

FIG. 1 is a schematic drawing showing the spiral shape forming of a spiral cold cathode fluorescent lamp according to the present invention.

FIG. 2 is a sectional view of a part of the spiral cold cathode fluorescent lamp according to the present invention.

FIG. 3 is a schematic drawing showing the status of the spiral cold cathode fluorescent lamp after spiral shape forming.

FIG. 4 is a top view of the spiral cold cathode fluorescent lamp according to the present invention.

FIG. 5 is a perspective view showing the spiral cold cathode fluorescent lamp installed in a lamp holder.

### DETAILED DESCRIPTION OF THE PREFERRED EMBODIMENTS

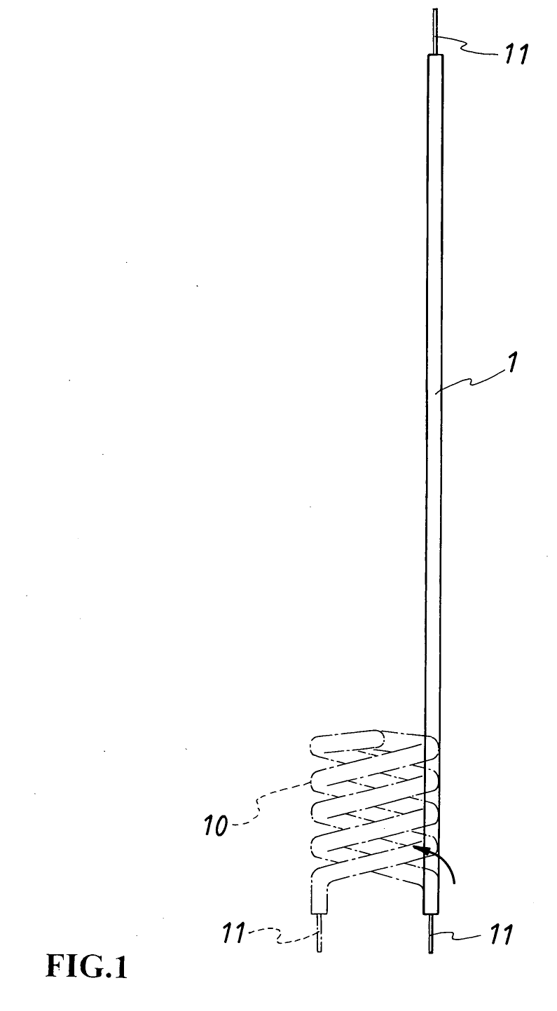

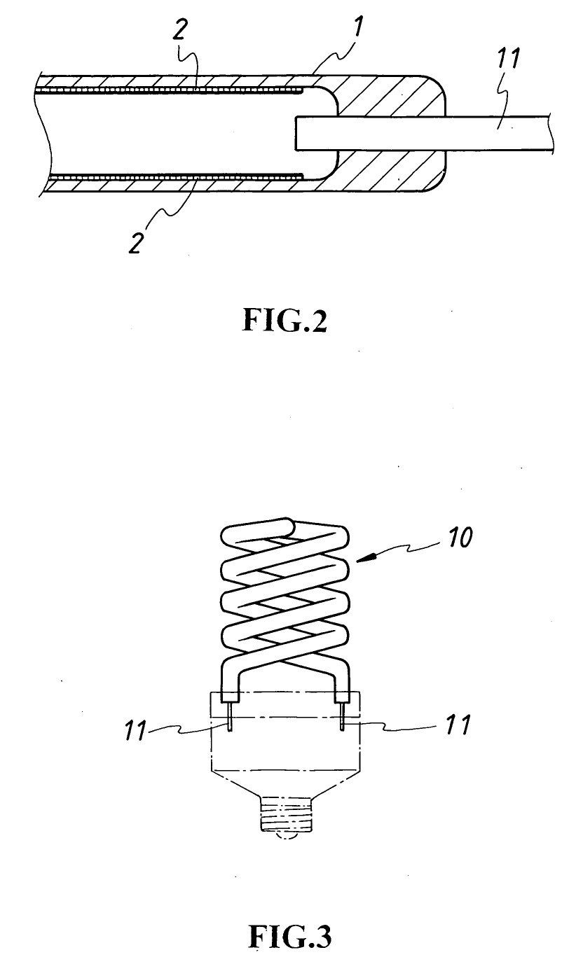

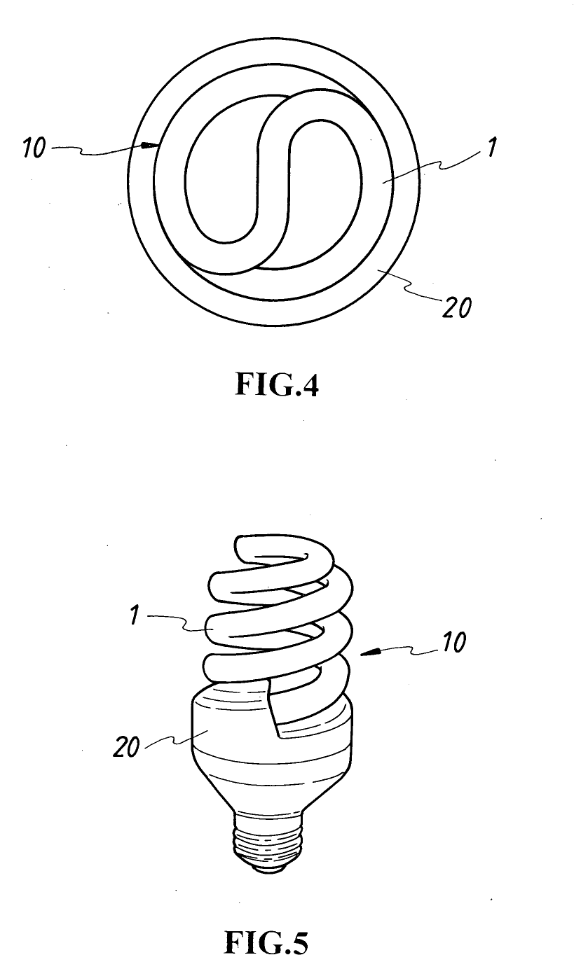

Referring to FIGS. 1 and 2, a spiral cold cathode fluorescent lamp in accordance with the present invention is comprised of a glass tube 1, a fluorescent material 2, an inert gas (not shown), and mercury (not shown). The glass tube 1 has an electrode 11 at each of the two ends thereof. The fluorescent material 2 is covered on the inside wall of the glass tube 1, forming a layer of fluorescent coating. The inert gas and mercury are enclosed inside the glass tube 1. The glass tube 1 has two bends bent inwards toward each other and spirally bent in reversed directions over each other under a high temperature environment, thereby forming a spiral cold cathode fluorescent lamp 10 (see FIGS. 3 and 4). The two electrodes 11 of the spiral cold cathode fluorescent lamp 10 are then installed in a lamp holder 20 to form a lighting fixture (see FIG. 5).

As indicated above, the invention has the originally straight lamp tube of a finished cold cathode fluorescent lamp be heated to a high temperature where the glass tube of the cold cathode fluorescent lamp is bendable, and then has the two ends of the glass tube be bent toward each other and bent spirally in reversed directions over each other without changing the positioning and distribution of the enclosed inert gas and fluorescent material. When cooled down, a spiral cold cathode fluorescent lamp is thus obtained. During discharging status upon the presence of electricity, electrons impact mercury atoms to emit ultraviolet light that causes the fluorescent material 2 to produce brilliant light.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A spiral cold cathode fluorescent lamp comprising a glass tube, said glass tube having two electrodes respectively installed in two distal ends thereof, a fluorescent material coated on an inside wall of said glass tube, an inert gas enclosed inside said glass tube, and mercury enclosed inside said glass tube, wherein said glass tube has the two distal ends thereof bent inwards toward each other and then spirally bent in reversed directions over each other under a high temperature environment, thereby forming a spiral cold cathode fluorescent lamp.

2. The spiral cold cathode fluorescent lamp as claimed in claim 1, further comprising a lamp holder electrically connected to the two electrodes of said glass tube.
